(19) United States
(12) Patent Application Publication
(10) Pub. No.: US 2004/0010722 A1
(43) Pub. Date: Jan. 15, 2004

(54) Computer system and method of controlling booting of the same

(75) Inventor: Jong-Uk Ha, Suwon City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/326,138

(22) Filed: Dec. 23, 2002

(30) Foreign Application Priority Data
Jul. 10, 2002 (KR) 2002-40081

(51) Int. Cl. H04L 9/00

(52) U.S. Cl. 713/202

(57) ABSTRACT

A computer providing a trace image booting password to control access to the computer. The computer includes a sensing plane; a sensor unit sensing a moving sensed unit contacting the sensing plane; an image generator generating a trace image along the movement of the sensed unit as sensed by the sensor unit; and an image storage storing a predetermined image password based upon a predetermined image. The computer further comprises a controller displaying the predetermined image on a display screen at a booting time of the computer to allow a user to move the sensed unit in contact with the sensing plane over the displayed predetermined image, comparing a trace image generated by the image generator along the moving trace of the sensed unit by the user with the stored image password, and booting the computer if the generated trace image corresponds to the stored image password.

### CROSS-REFERENCE TO RELATED APPLICATIONS

This application claims the benefit of Korean Application No. 2002-40081 filed Jul. 10, 2002, in the Korean Intellectual Property Office, the disclosure of which is incorporated herein by reference.

### BACKGROUND OF THE INVENTION

1. Field of the Invention

The present invention relates in general to computer systems, and more particularly, to a computer system whose booting is controlled through encoding of images, and a method of controlling booting of the computer system.

2. Description of the Related Art

Generally, computer systems are equipped with a function of creating passwords to restrain (prevent/restrict) third parties from accessing the concerned computer, thereby preventing unauthorized access to the information stored in the computer system.

A password for a computer system is usually established by selecting the function of creating the password at a menu of CMOS Setup, which is displayed when the ‘DEL’ key of the keyboard is selected before the computer is booted up. A user password established by the user at the CMOS Setup menu is stored in CMOS RAM, which is a non-volatile memory storing therein setup information of hardware units connected to the computer system.

When a power switch of the computer system is turned on, power is supplied to the computer system and the POST (Post On Self Test) process is then executed. During the POST process, a message requesting the user to insert a user password is displayed on the monitor. If the password input by the user via the keyboard corresponds to the user password stored in the computer system, the booting of the computer system is executed.

However, the conventional method of inputting the password has been disadvantageous in that the user has to remember the password, for example, by writing the password on a piece of paper, because typically the password is a combination of alphabets (letters/characters), numerals or special characters input from the keyboard, which are difficult to remember. Therefore, with the conventional passwords, there is a risk of forgetting the password or losing the written memo containing the password. Also, since the password may be orally disclosed by the user, it is highly likely that the password is disclosed to or can be misappropriated by a third person.

### SUMMARY OF THE INVENTION

Accordingly, it is an object of the present invention to provide a computer system with improved security, by establishing a trace image formed when a unit subject to be sensed (hereinafter a “sensed unit”) is moved from one location to another location on a sensing plate, thereby generating and/or providing a booting password preventing access to the computer by a third party. Further, the booting image-password improves the security level because it is more difficult to misappropriate than the conventional character booting passwords.

Additional objects and advantages of the invention will be set forth in part in the description which follows and, in part, will be obvious from the description, or may be learned by practice of the invention.

The foregoing and/or other objects of the present invention can be achieved by providing a computer system having a displaying apparatus, comprising a sensor main body having a sensing plane, with which a sensed unit is contacted and moved thereon; a sensor unit sensing the sensed unit contacting the sensing plane and moving thereon; an image generator generating a trace image along a motion of the sensed unit sensed (traced) by the sensor unit; an image storage unit storing therein a predetermined image password based upon a predetermined image; and a controller displaying the predetermined image divided into sections on the displaying apparatus at a booting time of the computer system to allow a user to move the sensed unit in contact with the sensing plane over the displayed sections of the predetermined image, comparing a trace image generated by the image generator along the moving trace of the sensed unit by the user with the stored image password, and allowing the computer to be booted up if the generated trace image corresponds to the stored image password.

According to an aspect of the present invention, the image password comprises a motion starting point of the sensed unit and an ending point thereof.

According to an aspect of the present invention, the sensor unit has a multiplicity of pressure sensors respectively corresponding to a multiplicity of position addresses on the sensing plane.

According to an aspect of the present invention, the sensed unit is a light pen illuminating lights, and wherein the sensor unit has a multiplicity of light sensors respectively corresponding to a multiplicity of position addresses on the sensing plane.

According to an aspect of the present invention, the image generator unit is an electronic pen recognizing movements of the pen on the sensing plane in real time and displaying the movements as an image.

According to an aspect of the present invention, the image password storage unit is provided within the CMOS RAM, and the controller unit reads the image password from the CMOS RAM at the time of booting the computer system and compares the read image password with the trace image generated by the image generator unit.

According to another aspect of the present invention, the above and other objects of the present invention may be also achieved by providing a method of controlling the booting of a computer system having a displaying apparatus equipped with a sensor unit on a display screen of the displaying apparatus through which an image can be displayed, the method comprising displaying a predetermined image screen at a time of booting the computer system; selecting a sensed unit so as to move the sensed unit from one section on the image screen to another section; sensing a contacted position according to a motion trace of the sensed unit on the image screen; generating a trace image based on the sensed contacted position information; reading an image password stored in advance; and allowing the computer system to be booted if the generated trace image corresponds to the image password after a comparison.

According to an aspect of the present invention, the image screen is divided into a plurality of sections.

According to an aspect of the present invention, the image password comprises a motion starting point of the sensed unit and an ending point thereof.

According to an aspect of the present invention, the method further comprises displaying an error message if the generated trace image does not correspond to the stored image password.

### BRIEF DESCRIPTION OF THE DRAWINGS

These and other objects and advantages of the present invention will become apparent and more readily appreciated from the following description of the embodiments, taken in conjunction with the accompanying drawings of which:

FIG. 1 is a structural diagram of a computer system, according to an embodiment of the present invention;

FIG. 2 is a control block diagram of the computer system shown in FIG. 1; and

FIG. 3 is a flow chart of controlling booting of the computer system shown in FIG. 1.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout.

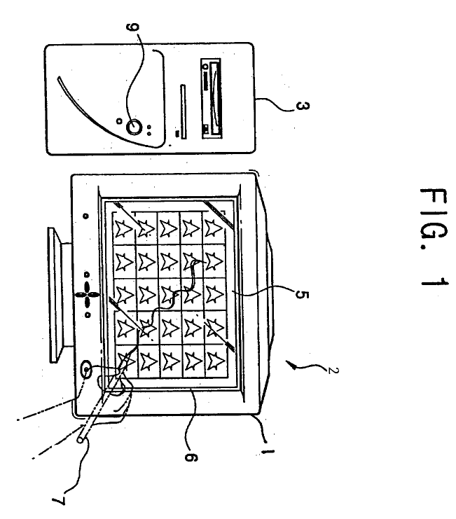

FIG. 1 is a structural diagram of a computer system according to an embodiment of the present invention. In FIG. 1, a computer system 2 comprises a displaying apparatus 1, which comprises a sensor main body having a sensor unit 5 as a sensing plane attached to a screen 6 of the displaying apparatus 1 and sensing a contact position of a sensed unit moving in contact with the sensing plane 5, and a computer main body 3 receiving position information provided from the sensor unit 5 along a movement of the sensed unit, and converting the position information into an image.

According to an aspect of the present invention, the sensed unit can be a pen 7 having a sharpened end. Hereunder, in the following embodiment to be described below, the sensed unit 7 will be specifically referred to as a “pen 7.”

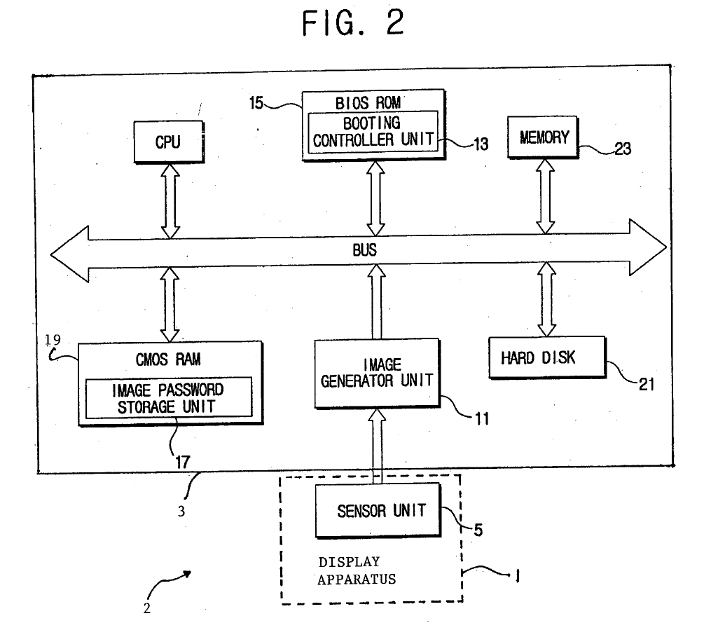

FIG. 2 is a control block diagram of the computer system 2 controlling booting via a generated trace image. As illustrated in FIG. 2, the computer system 2 comprises the sensor unit 5 as the sensing plane with which the sensed unit 7 can contact and be moved thereon to sense a motion (movement) of the sensed unit 7, an image generator unit 11 generating a trace image along the moving traces of the sensed unit 7 sensed by the sensor unit 5, an image password storage unit 17 storing therein predetermined image passwords based upon a predetermined image, and a booting controller unit 13 displaying the predetermined image divided into a plurality of sections on the displaying apparatus 1, at a time of booting the computer system 2, and controlling the booting of the computer system 2 by comparing a trace image provided from the image generator unit 11 along the motion of the sensed unit from one location to another location, with the image password stored in the image password storage unit 17 to determine whether the two images are identical (e.g., match or correspond to each other, etc.).

The stored image password comprises information on sections of a starting point (i.e., a starting point section) and of an ending point (i.e., an ending point section) of a predetermined sectioned image displayed on the display screen 6 while the pen 7 is moved on the displayed predetermined sectioned image to input a password image, and information on traces depending on a motion pattern from the starting section to the ending section. Of course, the predetermined sectioned image can be selected and/or generated by a user.

According to an aspect of the present invention, the sensor unit 5 of the sensor main body attached to the display screen 6 of the displaying apparatus 1 provides a sensing plane 5 comprising a plurality of pressure sensors (not shown) installed on intersections of columns and rows formed by structuring the display screen in a two-dimensional matrix. The two-dimensional matrix can have any number of elements, with a higher number of elements allowing more accurate position information of the sensed unit 7 on the sensing plane 5. An image displayed on the display screen 6 is also viewable through (i.e., shows through) the sensing plane 5. According to this, the sensing plane 5 outputs, on a digital basis, position information of the pressure sensors when the pen 7 in contact with the sensing plane 5 is moved from one section on the image screen to another section according to any pattern desired by the user. The sensor unit 5 supplies the digitalized output value to the image generator unit 11. The image generator unit 11 generates a trace information based on the sensed position information supplied from the sensor unit 5 and supplies the trace information to the booting controller unit 13.

In this embodiment, the booting controller unit 13 is realized as a booting control program stored in the BIOS ROM 15, which is driven at the time of booting up the computer system 2. In particular, at a booting time of the computer system 2, the booting controller unit 13 displays, on the display screen 6 of the display apparatus 1, the sectioned predetermined image as divided into a plurality of sections corresponding to the two-dimensional matrix of the sensing plane 5. As the user moves the pen 7 on the sensing plane 5 from one section of the displayed sectioned predetermined image to another section, the pressure sensors of the sensor unit 5 sense a position information of the pen 7, and the image generator unit 11 generates a trace image based on the sensed position information and thereafter supplies the generated trace image to the booting controller unit 13.

The booting controller unit 13 compares the trace image supplied from the image generator unit 11 with the image password stored in the image password storage unit 17 to determine whether the trace image is identical to the stored image. If the trace image is identical (e.g., matches, corresponds, etc.) to the stored image password, the booting controller unit 13 allows the computer system 2 to be booted. However, if the trace image is not identical to the stored image password, the booting controller unit 13 can display an error message on the displaying apparatus and deny access to the computer system 2 (i.e., the computer will not respond to commands or interact). In particular, the booting controller unit 13 authorizes the user when a trace image stored in advance in the image password storage unit 17 is identical to a pattern of a trace image input at a time of booting up the computer system 2.

According to an aspect of the present invention, the image password storage unit 17 is a readable and writeable CMOS RAM 19. The image password stored in the CMOS RAM 19 can be input after selecting a menu of Input Image Password provided in a displayed CMOS Setup screen (not shown) and pressing predetermined keys (DEL, F2, etc.) of the keyboard at the time of booting the computer system 2. Therefore, initially, a trace image can be stored in the CMOS RAM 19 as a password when the user selects the Menu of Input Image Password (not shown) on the CMOS Setup screen, and thereafter when the user desires to access the computer system 2, the user moves the pen 7 on the sensing plane 5 to form/allow generation of a predetermined pattern (i.e., trace image) from one section to another section on the same image used to input the stored image password of the user and displayed in sections on the screen 6 of the displaying apparatus 1 and through the sensing plane 5, thereby making a trace image via the image generator unit 11.

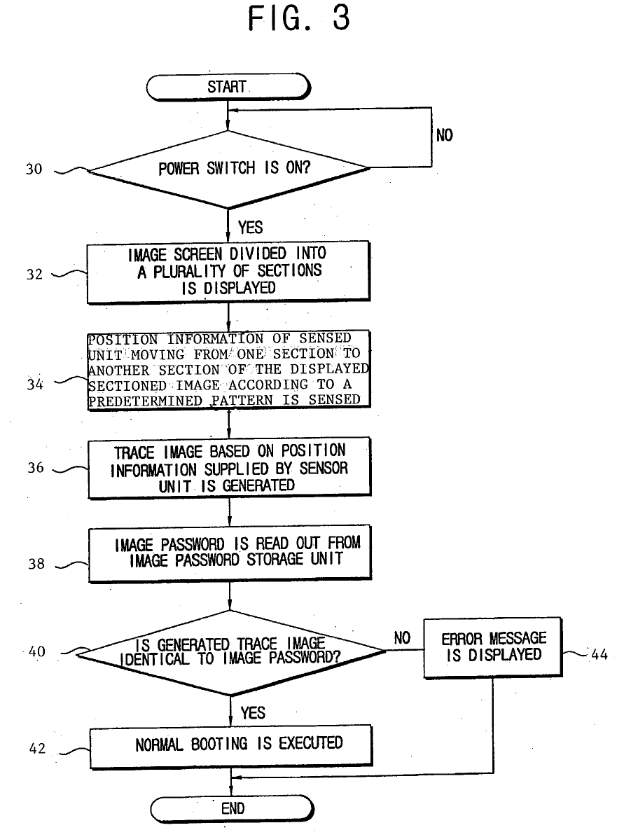

FIG. 3 is a flow chart of controlling booting of the computer system shown in FIG. 1. Typically, an image password is stored in advance in the CMOS RAM using the same method of generating a trace image as an image password. In particular, according to an aspect of the present invention, a booting control program of the present invention is executed after a booting program within the BIOS ROM is executed and connection to peripheral units, such as a sensor unit 5, is determined to be in order, at a time of executing the booting program in the BIOS ROM 15 of the computer system 2.

In particular, in FIG. 3, at operation 30, booting is selected when a power switch is turned on. The booting control program of the present invention is executed after the initial booting of each unit/component of the computer system 2 is completed. After the initial booting, at operation 32, an image screen divided into a plurality of sections is displayed on the display screen 6 of the displaying apparatus 1. At operation 34, the user places the pen 7 on the displayed sectioned image screen via the sensing plane 5 (i.e., the user contacts the pen 7 with the sensing plane 5 having a two dimensional matrix corresponding to the sections of the displayed image screen and through which the displayed sectioned image screen can be viewed) and moves the pen 7 from one section to another section of the displayed image according to a pattern desired by the user (i.e., a pattern that generates an image corresponding to the stored image password). Therefore, at operation 34, the sensor unit 5 attached to the screen 6 senses a position contacted by the pen 7 and provides the position information to the image generator unit 11.

At operation 36, the image generator unit 11 generates a trace image based on the position information supplied from the sensor unit 5 and supplies the generated trace image to the booting control program. At operation 38, the booting control program reads the image password stored in the CMOS RAM 19 and compares the read image password with the generated trace image. At operation 40, the booting control program determines whether the read image password and the generated trace image are identical (e.g., match or correspond to each other, etc.).

If the generated trace image and the stored image password are identical, at operation 42, the booting control program executes a normal booting process by reading the operating system of the computer system 2 from a hard disk 21 to load the operating system in a memory 23. However, if the generated trace image is not identical to the image password, at operation 44, the booting control program outputs an error message on the screen 6 of the displaying apparatus 1, notifying the user of the incorrect image password.

In the above-described embodiment, the sensor unit 5 senses pressure by the pen 7. However, the present invention is not limited to such a configuration and other known sensors generating a trace image corresponding to a moving pattern on a displayed image can be used as the sensor unit 5, such as (without limitation) a light pen illuminating lights and a light sensor sensing the lights can be employed as the sensor unit 5 in the present invention. Further, for example, a sensor unit 5 can comprise a display apparatus with a sensing (touch) screen, a sensed unit, such a pen, a finger, etc., and an image generator. Further, an image generator unit 11 can be provided as part of the sensor unit 5. Further, although, the above described trace image generation technique uses a see-through sensing matrix (sensing plane 5) on a display screen to map position information of a sensed unit on the sensing matrix to position information in an image displayed on the screen and viewable through the sensing matrix, the present invention is not limited to such a configuration. In particular, in the present invention, any known trace image generation technique using a sensed unit can be used. Further, the sensor unit 5 is in communication with the computer system 2 using known techniques.

Further, in the above-described embodiment, the booting control program of the present invention embodying the booting controller unit 13 is executed during the BIOS booting process driven when the power switch is turned on. However, the booting control program can be executed allowing the user to input the image password after the operating system is loaded on the memory 23 but displaying a normal initial operating system screen if the input image password (i.e., a generated trace image) is identical to the stored image password.

Further, in the above-described embodiment, the sensor unit 5 is mounted on the screen 6 of the displaying apparatus. However, the sensor unit 5 can be provided separate (i.e., not attached to the display apparatus 1) as a sensing plane on which a sensed unit 7 can be moved. For example, a sensing plane as the sensor unit 5 can be positioned horizontally next to the computer system 2 and in communication with the computer system 2. Further, although typically the sensor unit 5 is mounted on the screen 6 and see-through, the present invention is not limited to such a configuration and the sensor unit 5 could also be not see-through. For example, only a sensing matrix as the sensor unit 5 can positioned horizontally next to the computer system 2, wherein typically a user would rely on reproducing from memory a trace image (a pattern) based upon the sensing matrix.

Further, in the above-described embodiment, the image password is stored in the CMOS RAM 19. However, the present invention is not limited to such configuration and a separate readable and writeable storage unit in communication with or as part of the computer system 2 using known techniques can be used alternatively.

Further, in the above-described embodiment, the present invention is employed in desk-top computers, but the present invention can also be applied in portable computers, such as notebook computers, PDAs and palm PCs, and so on.

According to the present invention, access to a computer system by a third party (i.e., an unauthorized user) can be restricted by establishing, as a password, a trace image generated when a sensed unit is moved on an image screen. For example, the trace image can be generated when the image screen is divided into section and the sensed unit is moved from one section to another section of the sectioned image screen. Also, because the booting password is established as a trace image input by the user, easy misappropriation by the third party is significantly frustrated.

Therefore, the computer system 2 provides a trace image booting password to control access to the computer system. The processes of the present invention as embodied in the booting controller 13, the image generator 11 and the sensor unit 5 can be implemented in software and/or hardware. In particular, as described above, the present invention provides a computer system with an improved security level, by establishing a booting password based upon a trace image to prevent unauthorized access to the computer system. The trace image booting password is formed when a sensed unit is moved from one location to another location on a displayed image screen. Therefore, the security level of a computer system is significantly improved by using a trace image booting password, which is difficult to misappropriate because, for example, it cannot be orally disclosed to others.

Although an embodiment of the present invention has been shown and described, it will be appreciated by those skilled in the art that changes may be made in such embodiment without departing from the principles and spirit of the invention, the scope of which is defined in the appended claims and their equivalents.

What is claimed is:

1. A computer system having a displaying apparatus, comprising:
a sensor main body having a sensing plane, with which a sensed unit is contacted and moved thereon;
a sensor unit sensing the sensed unit contacting the sensing plane and moving thereon;
an image generator generating a trace image along a motion of the sensed unit as sensed by the sensor unit;
an image storage unit storing a predetermined image password; and
a controller displaying a predetermined image on the displaying apparatus at a booting time of the computer system to allow a user to move the sensed unit in contact with the sensing plane, comparing a trace image, which is generated by the image generator along the moving trace of the sensed unit by the user, with the stored image password, and allowing the computer system to be booted up if the generated trace image corresponds to the stored image password.

2. The computer system according to claim 1, wherein the displayed predetermined image is divided into a plurality of sections and the sensed unit is moved from one section to another section of the sectioned displayed predetermined image.

3. The computer system according to claim 1, wherein the image password comprises a motion starting point of the sensed unit and an ending point thereof.

4. The computer system according to claim 2, wherein the image password comprises a motion starting point of the sensed unit and an ending point thereof.

5. The computer system according to claim 1, wherein the sensor unit has a multiplicity of pressure sensors respectively corresponding to a multiplicity of position addresses on the sensing plane.

6. The computer system according to claim 1, wherein the sensed unit is a light pen illuminating lights, and
wherein the sensor unit has a multiplicity of light sensors respectively corresponding to a multiplicity of position addresses on the sensing plane and sensing the lights illuminated by the light pen.

7. The computer system according to claim 1, wherein the image generator unit is an electronic pen recognizing movements of the pen on the sensing plane in real time and displaying the movements as an image.

8. The computer system according to claim 1, wherein the image password storage unit is provided within a CMOS RAM, and the controller reads the image password from the CMOS RAM at the time of booting the computer system and compares the read image password with the trace image generated by the image generator.

9. A method of controlling booting of a computer system having a displaying apparatus equipped with a sensor unit on a display screen of the displaying apparatus and through which an image is displayed, comprising:
displaying a predetermined image screen at a time of booting the computer system;
choosing a sensed unit to move the sensed unit on the image screen;
sensing a contacted position according to a motion trace of the sensed unit on the image screen;
generating a trace image based on the sensed contacted position information;
reading an image password stored in advance; and
allowing the computer system to be booted if the generated trace image corresponds to the read image password after a comparison.

10. The method according to claim 9, wherein the image screen is divided into a plurality of sections and the sensed unit is moved from one section to another section of the sectioned image screen.

11. The method according to claim 9, wherein the image password comprises a motion starting point of the sensed unit and an ending point thereof.

12. The method according to claim 10, wherein the image password comprises a motion starting point of the sensed unit and an ending point thereof.

13. The method according to claim 9, further comprising displaying an error message if the generated trace image does not correspond to the image password.

14. A computer providing a trace image booting password to control interaction with the computer.

15. A computer system, comprising:
a display screen displaying an image;
a sensing plane, through which the image is viewable, positioned on the display screen and sensing movement of a sensed unit contacting the sensing plane;
an image generator generating a trace image based upon the displayed image and corresponding to the movement of the sensed unit; and
a controller comparing the generated trace image with a stored image based upon the displayed image and booting up the computer in response to the comparison.

16. A computer, comprising:
a sensing display screen displaying an image and sensing movement of a sensed unit contacting the screen;
an image generator generating a trace image based upon the displayed image and corresponding to the movement of the sensed unit; and
a controller comparing the generated trace image with a stored image based upon the displayed image and booting up the computer in response to the comparison.

17. A computer, comprising:
means for generating a trace image based upon a displayed image according to movement of a sensed unit on a sensing display screen displaying the image; and
means for booting up the computer if the generated trace image corresponds to a stored image.
